(19) United States
(12) Patent Application Publication
(10) Pub. No.: US 2021/0256853 A1
(43) Pub. Date: Aug. 19, 2021

(54) METHOD FOR CONTROLLING A VEHICLE IN A PLATOON

(71) Applicant: ZF ACTIVE SAFETY AND ELECTRONICS US LLC, Livonia, MI (US)

(72) Inventors: Ananda Pandy, West Lafayette, IN (US); Christopher Tharp, Westfield, IN (US)

(21) Appl. No.: 16/792,912

(22) Filed: Feb. 18, 2020

(51) Int. Cl. G08G 1/00; B60W 50/12; B60W 50/16; B60W 30/18

(52) U.S. Cl. CPC G08G 1/22; B60W 50/12; B60W 2050/143; B60W 30/18163; B60W 50/16

(57) ABSTRACT

A method of controlling platooning of a lead vehicle and at least one follow vehicle traveling in a first lane of a roadway includes indicating an intended lane change of the lead vehicle to a second lane. A third vehicle is detected in a blind spot of the at least one follow vehicle preventing the at least one follow vehicle from changing lanes to the second lane. A signal is sent from the at least one follow vehicle to the lead vehicle indicative of the prevention of the at least one vehicle to change lanes to the second lane. The lead vehicle is automatically prevented from changing lanes to the second lane in response to the signal.

### TECHNICAL FIELD

The present invention relates to controlling a vehicle in a platoon, and specifically to controlling a vehicle in a platoon during an attempted lane change.

### BACKGROUND

Automated following is a concept where a vehicle follows the path of a lead vehicle autonomously in defined boundary conditions. In order to operate the follow vehicle safely, sensors are used around the follow vehicle to detect any object in the path or predicted path of the follow vehicle. If any interruptions to the path is detected, one of the safe states for the follow vehicle is to decelerate to a stop in the path of the lead vehicle. When a follow vehicle comes to a stop, it can interrupt the mission and cause delays.

### SUMMARY

In one example, a method of controlling platooning of a lead vehicle and at least one follow vehicle traveling in a first lane of a roadway includes indicating an intended lane change of the lead vehicle to a second lane. A third vehicle is detected in a blind spot of the at least one follow vehicle preventing the at least one follow vehicle from changing lanes to the second lane. A signal is sent from the at least one follow vehicle to the lead vehicle indicative of the prevention of the at least one vehicle to change lanes to the second lane. The lead vehicle is automatically prevented from changing lanes to the second lane in response to the signal.

In another example, a method of controlling platooning of a lead vehicle and at least one follow vehicle traveling in a first lane of a roadway includes sending a signal from the lead vehicle to the at least one follow vehicle indicating an intended lane change of the lead vehicle to a second lane. A third vehicle is detected in a blind spot of the at least one follow vehicle preventing the at least one follow vehicle from changing lanes to the second lane. A signal is sent from the at least one follow vehicle to the lead vehicle indicative of the prevention of the at least one follow vehicle to change lanes to the second lane. A lane change assist system on the lead vehicle is automatically activated in response to the signal to prevent the lead vehicle from changing lanes.

Other objects and advantages and a fuller understanding of the invention will be had from the following detailed description and the accompanying drawings.

### BRIEF DESCRIPTION OF THE DRAWINGS

FIG. 1 is a schematic illustration of an example vehicle platoon including an example vehicle assist system.

FIG. 2 is a schematic illustration of a vehicle of the platoon.

FIG. 3 is a schematic illustration of components of the vehicle assist system.

### DETAILED DESCRIPTION

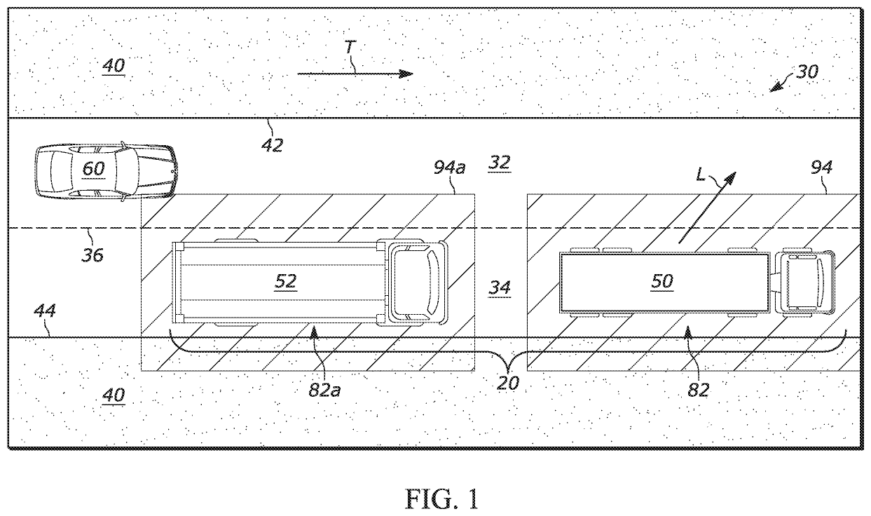

The present invention relates to controlling a vehicle in a platoon, and specifically to controlling a vehicle in a platoon during an attempted lane change. A method and system is provided for helping to control a vehicle in a platoon 20 traveling on a roadway 30 as shown in FIG. 1. The roadway 30 has a direction of vehicle travel illustrated by the arrow T. The roadway 30 includes a series of lanes 32, 34 separated by a dashed dividing line 36. Additional lanes and dividing lines are contemplated but not shown. The roadway 30 is separated from the surrounding off-road terrain 40 by a boundary line 42 on the left side (relative to the traveling direction T) and by a boundary line 44 on the right side.

The platoon 20 includes a first or lead vehicle 50 and one or more follow vehicles 52. For brevity, only a single follow vehicle 52 is shown. In any case, the platoon 20 is shown traveling in the right lane 34 in the direction T. A third or other vehicle 60 can be traveling in the adjacent lane 32. The vehicles 50, 52 in the platoon 20 can be a tractor-trailers (as shown) or the tractor without the accompanying trailer (not shown).

Although subsequent discussion focuses primarily on the components and functions thereof of the lead vehicle 50, it will be appreciated that the follow vehicle 52 (or any additional vehicle in the platoon 20 between the lead vehicle and follow vehicle shown) includes the same components and associated functions. This is because any one of the vehicles in the platoon 20 could act as the lead vehicle 50 during a particular route, trip, etc. and, thus, all the vehicles in the platoon 20 should be readily interchangeable to afford maximum flexibility. That said, components in the follow vehicle 52 corresponding with the same components in the lead vehicle 50 are given the suffix “a”.

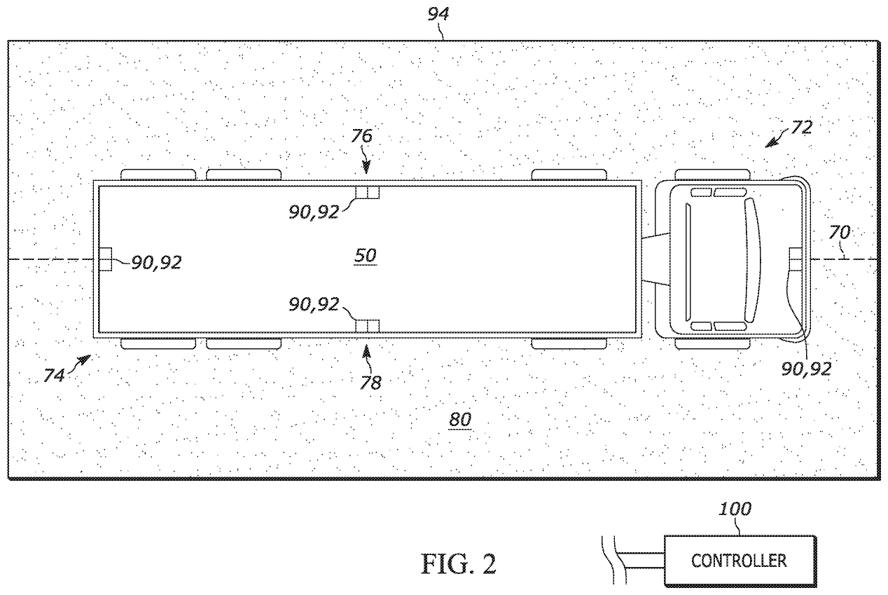

As shown in FIG. 2, the lead vehicle 50 extends along a centerline 70 from a front end 72 to a rear end 74. The lead vehicle 50 includes a left side 76 and a right side 78 positioned on opposite sides of the centerline 70. The vehicle exterior is indicated at 80.

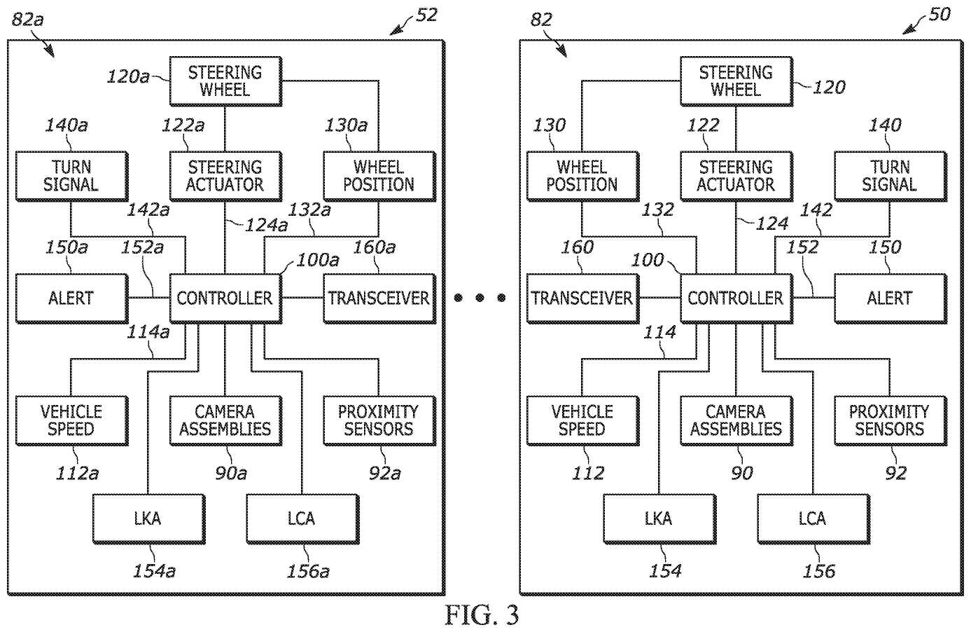

A vehicle assist system 82 (see also FIG. 3) is provided for helping to control aspects of lead vehicle 50 operation. The vehicle assist system 82 can include one or more monitoring features positioned around the periphery of the lead vehicle 50 for monitoring the exterior 80. As shown, the lead vehicle 50 includes camera assemblies 90 positioned at both ends 72, 74, i.e., on both the tractor and the trailer. Alternatively, the camera assemblies 90 can be mounted on just the tractor or just the trailer (not shown). In a combination vehicle, monitoring devices can be mounted either in the tractor alone or combination of tractor and trailer.

Each camera assembly 90 has a respective field of view covering a portion of the exterior 80. Collectively, the fields of view encircle the lead vehicle 50 as indicated generally by the shaded region 94. More or fewer camera assemblies 90 than what is shown in FIG. 2 and different shapes for the field of view 94 are contemplated. In any case, all of the camera assemblies 90 are electrically or wirelessly connected to a controller 100 on the lead vehicle 50.

The controller 100 continuously receives images taken by the camera assemblies 90 within the respective fields of view. The controller 100 includes an image processing module (not shown) that receives and analyzes the data associated with the images from the camera assemblies 90. The controller 100 can, for example, stitch the images together to form a 360° surround view (not shown) of the exterior 80 corresponding with the field of view 94. The images can also be relied on to identify objects/lanes around the lead vehicle 50.

Alternatively or additionally, at least one proximity sensor 92 is electrically or wirelessly connected to the controller 100 for acquiring data related to objects around the vehicle exterior 80. The at least one proximity sensor 92 can include, for example, laser scanners, ultrasonic sensors, radar detectors, and LIDAR detectors, for determining and monitoring the distance between the lead vehicle 50 and objects around the vehicle exterior 80, such as other vehicles. In one example, the proximity sensors 92 are provided at the same locations on the lead vehicle 50 as the camera assemblies 90. The proximity sensors 92 can have the same fields of view as the associated camera assemblies 90.

As shown in FIG. 3, the controller 100 is also electrically or wirelessly connected with various sensors and actuators in the lead vehicle 50 for monitoring and controlling several functions of the vehicle, namely, steering. To this end, the controller 100 is electrically or wirelessly connected to a vehicle speed sensor 112 for monitoring the lead vehicle 50 speed. The speed sensor 112 generates an electrical signal 114 indicative of the lead vehicle 50 speed that is sent to the controller 100 at predetermined time intervals.

The controller 100 is also connected to a steering wheel 120 through a steering actuator 122. A wheel position sensor 130 monitors the rotational angle of the steering wheel 120 and generates an electrical signal 132 indicative of the steering angle. The signal 132 is sent to the controller 100 at predetermined time intervals. The controller 100 can send a control signal 124 to the steering actuator 122 in response to the wheel position signal 132, thereby controlling rotation of the steering wheel 120. The steering actuator 122 actuation also controls the steering angle of the lead vehicle 50 wheels relative to the centerline 70.

A turn signal 140 constituting a lever or button is electrically or wirelessly connected to the controller 100 for notifying other vehicles when the lead vehicle 50 intends to changes lanes. To this end, the turn signal 140 automatically sends a signal 142 to the controller 100 when a lane change is intended. In response, the turn signal 140 actuates lights (not shown) on the lead vehicle 50 indicating its intended direction of lateral movement.

An alert 150 is electrically or wirelessly connected to the controller 100 for providing feedback to the operator of the lead vehicle 50 before and/or while autonomous operations are performed by the assist system 82. The alert 150 provides visual, audio or haptic feedback to the operator before and/or when the controller 100 sends a signal 152 thereto.

The vehicle assist system 82 can include a lane keep assist system (LKA) 154 that helps maintain the lead vehicle 50 within an intended driving lane in response to signals received by the controller 100 from the camera assemblies 90 and/or sensors 92, 112, 130. In particular, the lane keep assist system 154 can sense if the lead vehicle 50 is unintendedly deviating away from the lane and apply a steering force to the steering wheel 120 to keep the lead vehicle within the desired lane. A lane centering system (not shown) can be used in place of lane keep assist system.

The vehicle assist system 82 may also include a lane change assist system (LCA) 156 that helps the lead vehicle 50 change lanes along the roadway 30. The lane change assist system 156 can detect if a vehicle is in a lane to which the lead vehicle 50 intends to move during a lane change. If a vehicle is detected in the lane to which the lead vehicle 50 intends to move, the lane change assist system 156 can apply a steering force to the steering wheel 120 to keep the lead vehicle in the current lane, thereby preventing lane changing. In one example, the lane change assist system 156 detects whether another vehicle is in the blind spot of the lead vehicle 50.

Based on this construction, the controller 100 is capable of receiving continuous feedback regarding the driving conditions of the lead vehicle 50, e.g., vehicle speed and steering angle, data around the vehicle exterior 80, and the distance between the lead vehicle and objects identified. The controller 100, in response to these inputs, is capable of controlling vehicle operation in a manner that helps increase occupant and road safety.

The vehicles 50, 52 are connected with one another in a manner that allows for inter-vehicle communication, e.g., over-the-air communication using Dedicated Short Range Communication or V2V. For example, each vehicle 50, 52 in the platoon 20 can include a respective transceiver 160, 160a connected to its controller 100, 100a. The transceivers 160, 160a can be paired with one another in order to establish the peer-to-peer connection, which is also referred to as P2P or P2P connection. The P2P connection can be established via at least one physical channel such as, for example, DSRC, WiFi, LTE, etc. For example, the peer-to-peer connection can be established as a vehicle-to-vehicle connection (V2V) by which the vehicles 50, 52 are directly connected with each other and can exchange data directly.

In other words, the P2P is a V2V connection allowing a direct vehicle-to-vehicle communication by which the lead vehicle 50 receives the information signal directly from the follow vehicle 52. In other words, neither of the vehicles 50, 52 needs to communicate with a server or controller separate from the vehicles. It will be understood that any additional follow vehicles 52 provided in the platoon 20 can likewise send signals to the lead vehicle 50 and any other follow vehicle using the respective transceivers 160, 160a. With this in mind, the lead vehicle 50 can receive at least one signal from the follow vehicle(s) 52 indicative of another vehicle 60 traveling in the left lane 32 and affecting lane changing by the platoon 20.

Referring back to FIG. 1, in one example the lead vehicle 50 wishes to make a lane change from the right lane 34 to the left lane 32 as indicated generally by the arrow L. The controller 100 (and/or the driver, when present) determines that the left lane 32 is sufficiently clear to allow for the lane change. To this end, the lead vehicle 50 can rely on the camera assemblies 90 and/or proximity sensors 92 to determine that no vehicles are present in the field of view 94 in the left lane 32 and therefore changing lanes is appropriate.

When this occurs, the turn signal 140 is actuated to send a signal 142 to the controller 100 to turn on the turn signal lights and visually indicate to the follow vehicle 52 that a lane change is desired. At the same time, the transceiver 160 of the lead vehicle 50 sends a signal to the transceiver 160a of the follow vehicle 52 indicating that a lane change by the lead vehicle is desired.

In response to receiving the signal from the lead vehicle 50, the follow vehicle 52 inspects its field of view 94a to determine if a vehicle is present in the left lane 32 that prevents safe lane changing, e.g., a vehicle present in the blind spot of the follow vehicle. As shown, the controller 100a of the follow vehicle 52 determines another vehicle 60 is present within the field of view 94a in the blind spot based on signals from the camera assemblies 90a and/or the signals from the proximity sensors 92a. The controller 100a can further determine—based on the detected speed and projected path of the other vehicle 60—that changing lanes from the right lane 34 to the left lane 32 is likely to result in a vehicle collision with the other vehicle.

In response, the controller 100a of the follow vehicle 52 remains in the right lane 34 and informs the lead vehicle 50 of its intention to remain in the right lane. In other words, the follow vehicle 52 relies on the transceivers 160, 160a to inform the lead vehicle 50 that safe lane changing is not possible and therefore the platoon 20 should remain in the current lane 34. To this end, the follow vehicle 52 sends information related to the detected other vehicle 60, e.g., its speed, location, projected path, etc., to the lead vehicle 50.

The controller 100 of the lead vehicle 50 receives this info and automatically activates/enables the lane change assist system 156 to prevent the intended lane change of the lead vehicle. At the same time, the controller 100 sends the signal 152 to the alert 150 to notify the operator of the lead vehicle 50 that the follow vehicle 52 cannot change lanes. As a result, the controller 100 of the lead vehicle 50 monitors the distance between the lead vehicle and the dividing line 36 and corrects the position of the lead vehicle when needed. To this end, the controller 100 sends the signal 124 to the steering actuator 122 to rotate the steering wheel 120 and thereby move the lead vehicle laterally towards the center of the right lane 34.

On the other hand, if no vehicle is detected in the blind spot of the follow vehicle 52, the follow vehicle sends a signal indicative of no vehicle detection to the lead vehicle 50. In response, the lead vehicle 50 does not activate (or deactivates) the lane change assist system 156 and is therefore permitted to make the intended lane change to the left lane 34. At the same time, the follow vehicle 52 also makes the lane change to the left lane 34 behind the lead vehicle 50.

It will be appreciated that when additional follow vehicles 52 are provided in the platoon 20 each follow vehicle checks the respective blind spot for other vehicles. If any follow vehicle 52 detects another vehicle in their blind spot, a signal is sent to each vehicle in the platoon 20 activating the respective lane change assist system 156, 156a to prevent any vehicles in the platoon 20 from changing lanes. If none of the vehicles 50, 52 in the platoon 20 detect another vehicle in their respective blind spot the lane change assist system 156, 156a in each vehicle is not activated/deactivated and the platoon is permitted to make the intended lane change.

The vehicle assist system described herein is advantageous because it actively prevents platoon lane changing when one (or more) of the follow vehicles detects another vehicle in its blind spot. By actively/automatically suppressing the lead vehicle lane change assist system without input/feedback from the lead vehicle operator the assist system described herein helps to increase the safety of changing lanes by a platoon.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method of controlling platooning of a lead vehicle and at least one follow vehicle traveling in a first lane of a roadway, comprising the steps of:
indicating an intended lane change of the lead vehicle to a second lane;
detecting a third vehicle in a blind spot of the at least one follow vehicle preventing the at least one follow vehicle from changing lanes to the second lane;
sending a signal from the at least one follow vehicle to the lead vehicle indicative of the prevention of the at least one follow vehicle to change lanes to the second lane; and
automatically preventing the lead vehicle from changing lanes to the second lane in response to the signal.

2. The method of claim 1, wherein the step of indicating an intended lane change comprises sending a signal to the follow vehicle indicative of the intended lane change.

3. The method of claim 1, wherein the lead vehicle is automatically prevented from changing lanes by activating a lane change assist system on the lead vehicle.

4. The method of claim 1, wherein the signal includes data indicative of a projected path of the third vehicle.

5. The method of claim 1, wherein the signal includes data indicative of a speed of the third vehicle.

6. The method of claim 1, further comprising alerting the operator of the lead vehicle of the signal.

7. The method of claim 1, further comprising alerting the operator of the lead vehicle of being automatically prevented from changing lanes.

8. The method of claim 1, wherein the alarm is an audible alarm.

9. The method of claim 1, wherein the alarm is a visual alarm.

10. The method of claim 1, wherein the alarm is a haptic alarm.

11. The method of claim 1, wherein the at least one follow vehicle comprises multiple follow vehicles, the lead vehicle being prevented from changing lanes to the second lane in response to the signal from any of the follow vehicles.

12. A method of controlling platooning of a lead vehicle and at least one follow vehicle traveling in a first lane of a roadway, comprising the steps of:
sending a signal from the lead vehicle to the at least one follow vehicle indicating an intended lane change of the lead vehicle to a second lane;
detecting a third vehicle in a blind spot of the at least one follow vehicle preventing the at least one follow vehicle from changing lanes to the second lane;
sending a signal from the at least one follow vehicle to the lead vehicle indicative of the prevention of the at least one follow vehicle to change lanes to the second lane; and
automatically activating a lane change assist system on the lead vehicle in response to the signal to prevent the lead vehicle from changing lanes.

13. The method of claim 12, wherein the signal includes data indicative of a projected path of the third vehicle.

14. The method of claim 12, wherein the signal includes data indicative of a speed of the third vehicle.

15. The method of claim 12, further comprising alerting the operator of the lead vehicle of the signal.

16. The method of claim 12, further comprising alerting the operator of the lead vehicle of being automatically prevented from changing lanes.

17. The method of claim 12, wherein the alarm is an audible alarm.

18. The method of claim 12, wherein the alarm is a visual alarm.

19. The method of claim 12, wherein the alarm is a haptic alarm.

20. The method of claim 12, wherein the at least one follow vehicle comprises multiple follow vehicles, the lead vehicle being prevented from changing lanes to the second lane in response to the signal from any of the follow vehicles.
